(19) United States
(12) Patent Application Publication
(10) Pub. No.: US 2012/0013941 A1
(43) Pub. Date: Jan. 19, 2012

(54) Dedicated SMS and wireless telephony communication device and method

(76) Inventor: Robert Sweeney, Parkville, MO (US)

(21) Appl. No.: 13/065,281

(22) Filed: Mar. 18, 2011

Related U.S. Application Data
(60) Provisional application No. 61/399,723, filed on Jul. 16, 2010.

(51) Int. Cl. G06F 3/12

(52) U.S. Cl. 358/1.15

(57) ABSTRACT

A method and device for operating a mobile communications system includes a text message receiver and a printer for printing text messages. The method includes the steps of:

providing a website connected to the Internet, and receiving an automatic message from the mobile communication device, the message including an electronic serial number. The method assigns a mobile phone number to the device based on the electronic serial number and sends the phone number to the device and can automatically print out the phone number. The device can include a holder for displaying the phone number label on an exterior surface of the device housing. The device receives and prints text or other materials received by SMS messaging and can allow the user to send greetings, reply and send an urgent message in an emergency. The device includes action buttons that can be programmed to perform other functions.

### CROSS REFERENCES TO RELATED APPLICATIONS

Applicant claims priority under 35 USC 119 to provisional application 61/399723 filed Jul. 16, 2010 with the title “Dedicated SMS Enterprise Communication printer device and method”.

Statement as to Rights to inventions made under Federally sponsored research and development:

Not applicable.

### BACKGROUND OF THE INVENTION

1. Field of the Invention

This present invention relates generally to text messages, SMS and wireless data communication.

2. Background Information

In the communication industry it is common to use cell phones for mobile communication and to receive text messages. A problem with existing technology is that it can be overly complicated for the elderly and disabled and other users and often the small buttons and small screens of cell phone devices are difficult to use for those who are elderly or disabled. Further as it relates to mobile devices there is a need in many applications for tangible documentation that cell phones and other mobile devices do not provide.

### SUMMARY OF THE INVENTION

The present invention solves the problems outlined above. A method and device for operating a mobile communications system includes a text message receiver and a printer for printing text messages. The method includes the steps of:

providing a website connected to the Internet, and receiving an automatic message from the website. The message including an electronic serial number.

The method assigns a mobile phone number to the device based on the electronic serial number and sends the phone number to the device and automatically printing out the phone number. The device includes a holder for displaying the phone number label on an exterior surface of the device housing. The device receives and prints text messages or other material and allows the user to have at least one action button that might send greetings, reply or send an urgent message in an emergency for example. The action button could be programmed to perform other actions.

### BRIEF DESCRIPTION OF THE DRAWINGS

FIG. 1 is a view of one embodiment of the device;

FIG. 2 shows one possible relational diagram for the device;

FIG. 3 shows a flow chart for the device operation;

FIG. 4 shows a diagram of the device and

FIG. 5 shows a flowchart for the device.

### DESCRIPTION OF THE PREFERRED EMBODIMENTS

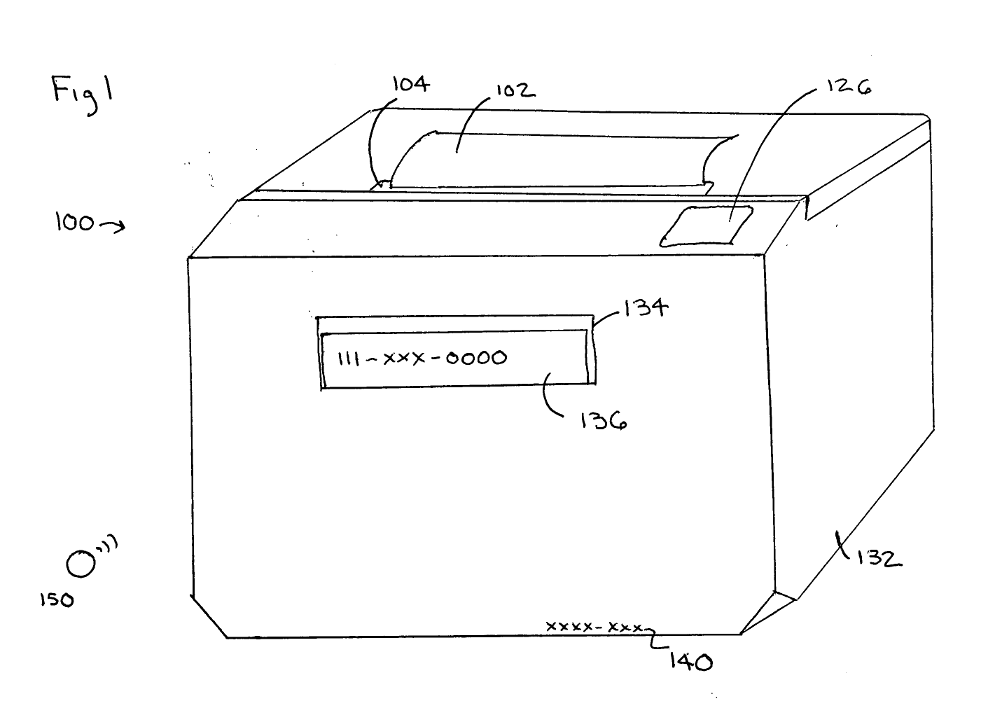

FIG. 1 illustrates a preferred embodiment of a communication device 100 using the invention. The device 100 receives wireless signals such as SMS, text messages and wireless data communications for example. The device 100 includes an internal printer that can print messages 102 or other material on hard copy such as a thermal paper and can be battery powered for remote use. The printer device 100 includes a slot 104 that a printed message 102 comes through and a lighted action button 126 that can light red if paper is out and green if a message is waiting, this light can be separate or can be incorporated into the action button 126. The device 100 can include a speaker that can pronounce messages such as reminders to take medicine and it can produce a sound such as a tweet when a message is waiting. The device 100 includes at least one action button 126 and could include more. The lighted action button 126 can send a reply to acknowledge receipt of a message or to participate in a survey for example. A second button could send a special message such as an urgent warning. For example, the button might automatically send a warning message from an elderly owner to an adult child that the owner needs help. For example, if an adult child sends the elder owner a text message the owner can acknowledge receipt of the message by pressing the reply action button 126. The action button 126 can be programmed to serve other functions, for example the device 100 could be set up as a remote financial terminal that could send payment information, receive verification of funds availability, ask for and send transaction verification and print out a receipt for the customer and transaction information for the user. Alternatively the device 100 could have only one button to send a message to acknowledge receipt of a message back to the sender of the message. The device 100 includes a cube shaped housing 132 and has a transparent holder 134 on the housing 132. The holder 134 can hold a printed message 136 and/or other indicia such as a person's name. The housing 132 includes an electronic serial number 140 prominently displayed on the outside.

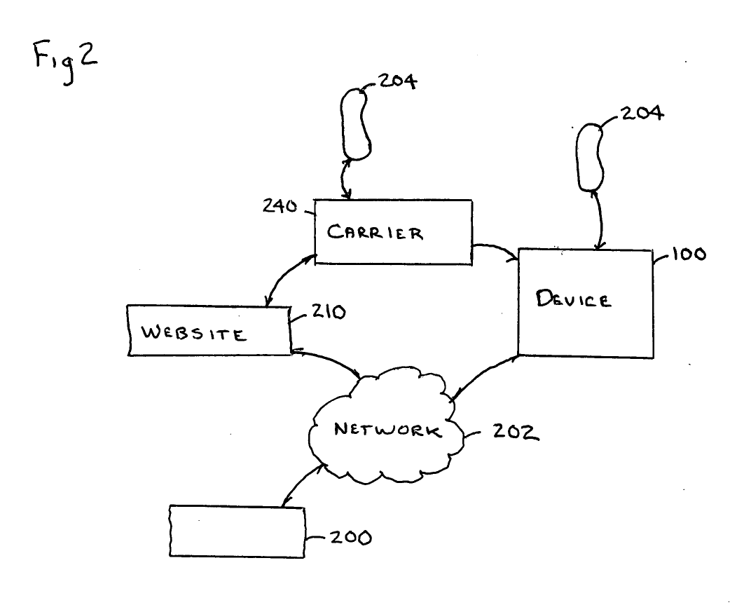

FIG. 2 shows a first possible relational diagram for the device 100. The device 100 can be programmed through a computer 200 directly or via a communication network 202 like a wireless carrier or a public network like the internet. The website 210 can automatically access a device 100 through the Internet 202 or a wireless cellular data network. A communication device such as cell phone 204 can send a text message via SMS to the device 100 and the contents of the text message will be printed out. When the device 100 is purchased, turned on and connected to the Internet 202 it will connect automatically to a website 210 that will download a phone number from a cell phone carrier 240 and the website will send that number to the device via the Internet 202 and the number will print out on the device 100.

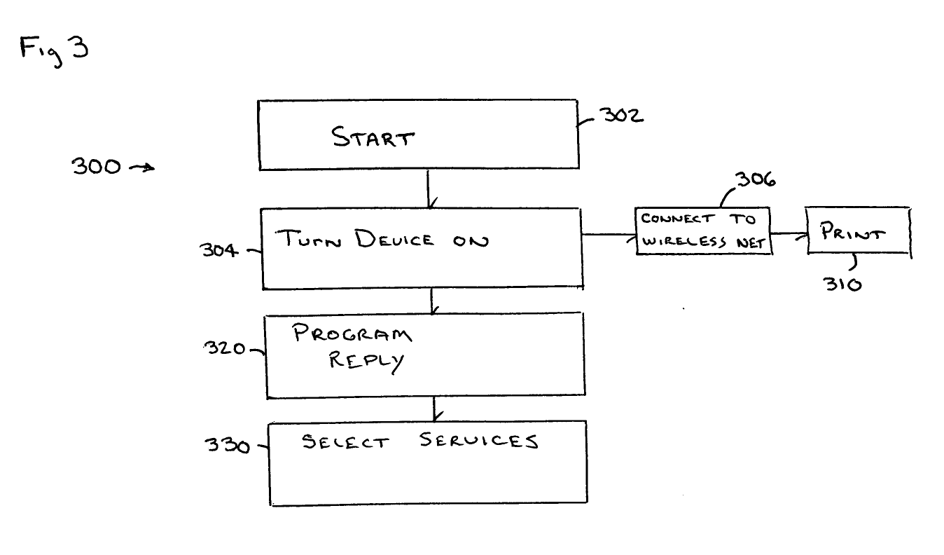

FIG. 3 shows a flow chart for the start up process 300 for this device 100. The flow chart 300 process starts 302 with a user getting the device 100 such as buying it at the store or receiving it through the mail or can start at the time of manufacture for example. The user will turn the power on and connect the device 100 into a wireless cellular data network. The device 100 is ‘hot’ in that when connected to the wireless cellular data network and turned on 304 it will automatically connect via the wireless cellular data network 202 to a website 240 specific to the product. The website 240 will prompt the user through a series of registration screens and will ask for the user's electronic serial number 140 and zip code. Based on the unique electronic serial number and zip code the website will communicate via the wireless cellular network and assign the device 100 a phone number from a cell phone carrier 240 using over the air configuration. The device 100 will then automatically print 310 its phone number to form a label 136 that can be displayed on the device 100 so that an elder user will always know the phone number. The mobile phone number will also be retained by the website 240 and can be retrieved by entering the electronic serial number and/or a password. While connected to the website 210 a user can program user button 126. The user can program a reply 320 if needed and select the users to receive that text message whenever the button 126 is pushed. The user will also have the option to select to receive services 330 such as coupons that would print out on the device, weather alerts, amber alerts or other information service options.

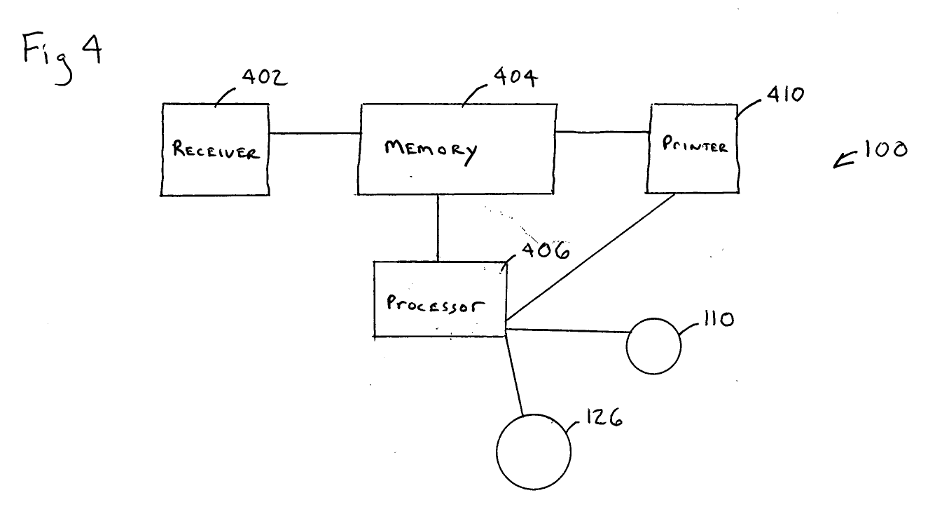

FIG. 4 shows a diagram of the device 100. The device 100 includes a communication module receiver 402 that has a mobile phone number. The receiver 402 saves a message in a memory 404. A processor 406 will pull incoming text messages from the memory 404 and send them to a printer 410, the processor 406 will also allow the senders phone number to print out on the message. The receiver 402 also receives text messages from a website 210, these text messages include data to program button 126 messages. The text messages for these outputs are also stored in the memory 404 and are sent out to lists of recipients also sent from the website 210 and stored in the memory 404. The process by which a user may create a phonebook in device 100 by entering names and numbers into a website, then using wireless cellular data communication, the website calls device 100 and stores the phonebook entries in memory 404. Then, when a user receives a text message from a number listed in their phone book, both the name and the number of the sender is printed 102.

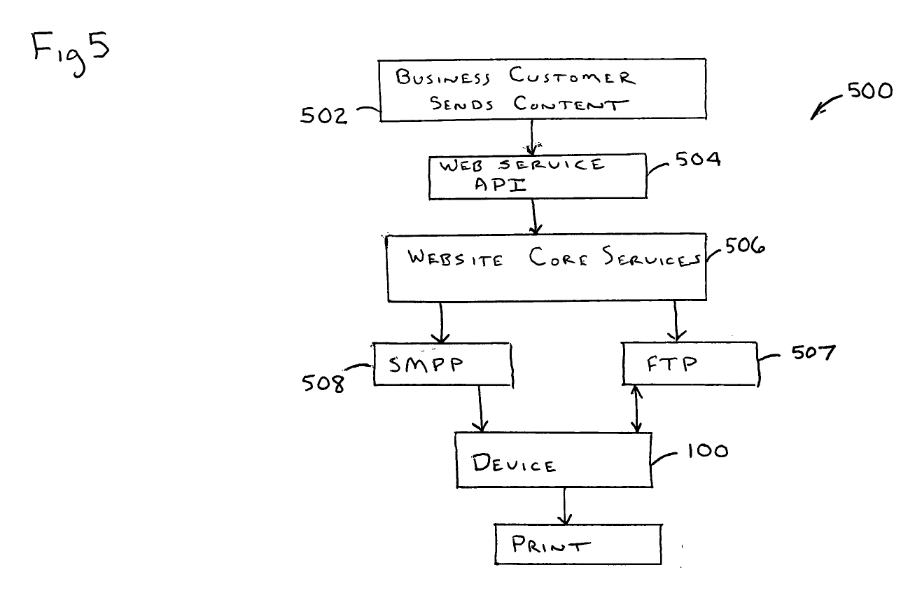

FIG. 5 shows an alternate business flow process 500 using the device 100. A source such as a business customer wants to send 502 an HTML or XML message to one or several devices 100. For example, a customer may have a coupon to send to a plurality of device users who have chosen to receive coupons from this business. The business customer will use a device application programming interface (API) 504 to post a graphic file and message via web service to web core services 506. A sample message might be:

<doc>
<img src=”client_logo.png”/>
<b>SPECIAL OFFER</b>br
Show this coupon and receive $10
off the purchase of 1-month supply
of your prescription medication.
<barcode values “2500274135”/>
</doc

The HTML or XML message request from the business customer is received by core services 506. Core services 506 turns the message into a text and/or graphic file on a File Transfer Protocol (FTP). The FTP file for the sample message would look like:

File:”c234” created on FTP server.
SPECIAL OFFER
Show this coupon and receive 1-month
supply of your prescription medication.
mQ#0830 (i.e. Barcode cmd) 2500274135

Once the HTML or XML file is created and saved as file c234, the core service will send an SMS message 508 such as: SMS=mQ#09234 to the device 100 via a direct wireless carrier peer to peer connection. The device 100 will then send a request to the FTP server (in this case ‘c234’ via a wireless cellular data connection). File ‘c234’ is returned via a wireless cellular data connection then printed. In this case the user the user would receive a coupon identifying a business and offering $10 off the purchase of a 1 month supply of medicine. The coupon would display a graphic logo at the top and a barcode at the bottom.

Using the Web Service API 504, a business customer 502 may also send an HTML or XML file directly to device 100. This file is received by 402, stored in memory 404, then processed 406 automatically by device 100 by communicating via the wireless data network to the Internet, capturing one or more graphic files and then assembling a file that includes graphics and text to be printed on device 100. The file for the sample message might look like:

<doc>
Get Your Free Drink Today !!
<img src=http://website.at/software/dither/dither1.png/>
This healthy choice brought
To you by ABC Stores!!
<ima src=http://trade.mar.cx/images/WX7654321/>
</doc>

After the startup process 300 the device 100 will be turned on ready to use and does not require Internet connection. In use if the device 100 receives a text message and the green light will display and the message will print out at printer slot 104, the message can include the phone number and name of the sender which is stored in the memory. By printing the phone number and name with the message the user can identify the sender and has the option to call the sender to respond to the message. If more messages are received they will print in order on the paper 102 until the paper 102 is torn off to be read. When the messages are read the user can press the reply button 126 to acknowledge message receipt to the last phone number from which a message was received. The user can also press button 126 to advance the paper through slot 104. The acknowledgement message can be in the form of a pre-recorded text message. The reply serves to assure the message sender such as an adult child that there elderly parent is OK. If no reply is needed the message sender can simply say no response required in their message and the device 100 user always has the option not to send a response. If the user opts in for message services they might receive weather reports, coupons or reminders such as to take medicine for example.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A method of operating a mobile communications device includes a text message receiver and a printer for printing text messages, the method including the steps of:
providing a website connected to a network,
receiving an automatic message from said device to said website,
said message including an electronic serial number,
assigning a mobile phone number to said device based on said electronic serial number;
sending said phone number to said device and automatically printing out said phone number.

2. The method of claim 1 wherein said printer includes a transparent pocket to receive said printout of said phone number and wherein said automatic message is sent by the device automatically when the device is turned on a first time.

3. The method of claim 1 wherein said method includes said website receiving a coded coupon from a business and said coupon is saved as an FTP file and an SMS message is sent from said website to said device providing a file number the device can use to retrieve said FTP file.

4. The method of claim 1 wherein said device receives additional SMS messages and those messages can be printed out and wherein contact information for the sender of the messages can be recalled from a device memory and printed with the message.

5. The method of claim 1 wherein a user of said device acknowledges receipt of a message by pushing a single button that triggers the device to send a text message.

6. The method of claim 3 wherein said coupon is printed out from said device.

7. The method of claim 3 wherein the FTP file is automatically retrieved by the device from the website and is then printed out.

8. A method of operating a mobile communications device includes a text message receiver and a printer, the method including the steps of:
providing a website connected to the Internet,
receiving an automatic message from said device to said website,
wherein said message is automatically sent when the device is turned on a first time,
said message including a serial number,
assigning a mobile phone number to said device based associated with said serial number;
sending said phone number to said device and said device automatically printing out said phone number.

9. The method of claim 8 wherein said device includes a transparent pocket to receive said printout of said phone number and wherein said automatic message is sent by the device automatically when the device is turned on a first time.

10. The method of claim 8 wherein said method includes,
said website receiving a message from a business and
said message is saved as an FTP file and an SMS message is sent from
said website to said device providing a file number the device can use to retrieve said FTP file from the website.

11. The method of claim 9 wherein said message is a coupon.

12. The method of claim 9 wherein said device receives additional messages from a cell phone and those messages can be printed out and wherein contact information for the sender of the messages can be recalled from the website and stored in a device memory and then recalled from the device memory and printed.

13. The method of claim 9 wherein a user of said device acknowledges receipt of a message using a single button that triggers the device to send a text message.

14. The method of claim 11 wherein said coupon is printed out from said device.

15. The method of claim 11 wherein the FTP file is automatically retrieved by the device from the website and is then printed out.

16. A method of operating a communications device includes a text message receiver and a printer, the method including the steps of;
providing a website connected to the Internet,
sending an automatic message from said device to an receiving said website, wherein said message is automatically sent when the device is turned on a first time,
said message including a serial number,
assigning a mobile phone number to said device based associated with said serial number;
sending said phone number to said device and said device automatically printing out said phone number.

17. The method of claim 16 wherein said device includes a pocket to receive said printout of said phone number and wherein said automatic message is sent by the device automatically when the device is turned on a first time.

18. The method of claim 16 wherein said method includes, said website receiving a message from a source and said message is saved as an FTP file and an SMS message is sent from said website to said device providing a file number the device can use to retrieve said FTP file from the website.

19. The method of claim 18 wherein said message is a coupon.

20. The method of claim 19 wherein a user of said device acknowledges receipt of a message using a single button that triggers the device to send a text message and wherein contact information for the sender of the messages can be recalled from a device memory and printed with the message.
